(19) United States
(12) Patent Application Publication
(10) Pub. No.: US 2024/0209511 A1
(43) Pub. Date: Jun. 27, 2024

(54) METAL-PLATED BORON NITRIDE NANOMATERIALS AND METHOD OF PRODUCING THE SAME

(71) Applicant: Technology Innovation Institute-Sole Proprietorship LLC, Masdar City (AE)

(72) Inventors: Abdulla Al Shehhi, Khalifa City (AE); Monserrat Gutierrez Munoz, Abu Dhabi (AE); Nesma Aboulkhair, Abu Dhabi (AE); Federico Bosio, Abu Dhabi (AE); Chinmay Phutela, Abu Dhabi (AE); Afra Saeed Mubarak Jezaie AlKetbi, Sharjah (AE); Nitul Rajput, Khalifa City (AE)

(73) Assignee: Technology Innovation Institute-Sole Proprietorship LLC, Masdar City (AE)

(21) Appl. No.: 18/390,049

(22) Filed: Dec. 20, 2023

Related U.S. Application Data
(60) Provisional application No. 63/434,143, filed on Jan. 31, 2024.

(51) Int. Cl. C23C 18/16; C23C 18/18; C23C 18/31

(52) U.S. Cl. CPC C23C 18/1639; C23C 18/1692; C23C 18/1893; C23C 18/31; B82Y 40/00

(57) ABSTRACT

The present disclosure describes a method of a preparing a metal-plated boron nitride nanomaterial, which may perform a surface treatment on the boron nitride nanomaterial to form a treated boron nitride nanomaterial. The method may contact the treated boron nitride nanomaterial with an activating solution to form an activated boron nitride nanomaterial. The method may contact the activated boron nitride nanomaterial with an accelerator solution to form an accelerated boron nitride nanomaterial. The method may contact the accelerated boron nitride nanomaterial with a plating solution comprising a metal to form a plated boron nitride nanomaterial. The method may dry the plated boron nitride nanomaterial.

### CROSS-REFERENCE TO RELATED APPLICATIONS

This application claims priority to U.S. Provisional Patent Application No. 63/434,143, which was filed on Dec. 21, 2022, the entire contents of which are incorporated by reference herein.

### FIELD

The present disclosure relates generally to metal-plated boron nitride nanostructures/nanomaterials and methods of producing the same. More specifically, the disclosure relates to the electroless plating of boron nitride nanomaterials with various metals.

### BACKGROUND

Boron nitride (BN) nanomaterials obtain excellent properties such as robust mechanical strength, high thermal conductivity, electrically insulating behavior, neutron shielding capabilities, and great oxidation resistance.

Boron nitride nanomaterials and other nanoparticles have been employed in polymer and metallic composites to improve the properties of the original material. However, nanoparticles including Boron nitride nanomaterials tend to agglomerate and cluster, such that the nanomaterials seldom achieve good dispersion throughout the composite. Excellent dispersion of the nanomaterials throughout the composite is important to realizing the performance enhancement offered by BN nanomaterials and other nanostructures.

Accordingly, it is desirable to functionalize the boron nitride nanomaterials such that they more readily disperse throughout the composite. Incorporating metals into BN nanomaterials has been investigated via implanting metal ions into the BN nanomaterial's structure, along with filling the BN nanomaterials with metals. The methods described in the prior suffer from numerous drawbacks, such as electrochemical methods which require either limited metal options or expensive equipment and reagent, or methods which inconsistent incorporation of metal into the BN. It is thus necessary to identify methods of introducing a variety of metals to BN that are scalable, affordable, and offer reliable metal incorporation.

### SUMMARY

In aspects, the techniques described herein relate to a method of producing a metal-plated boron nitride nanomaterial, including steps of: performing a surface treatment on a boron nitride nanomaterial to form a treated boron nitride nanomaterial; contacting the treated boron nitride nanomaterial with an activating solution to form an activated boron nitride nanomaterial; contacting the activated boron nitride nanomaterial with an accelerator solution to form an accelerated boron nitride nanomaterial; contacting the accelerated boron nitride nanomaterial with a plating solution including a metal to form a plated boron nitride nanomaterial; and drying the plated boron nitride nanomaterial.

In aspects, the techniques described herein relate to a method, wherein the surface treatment includes contacting the boron nitride nanomaterial with a solution of an acid.

In aspects, the techniques described herein relate to a method according to any of the above aspects, wherein the surface treatment including contacting the boron nitride nanomaterial with an acid including hydrochloric acid, sulfuric acid, nitric acid, or combinations thereof.

In aspects, the techniques described herein relate to a method according to any of the above aspects, further including rinsing the treated boron nitride nanomaterial.

In aspects, the techniques described herein relate to a method according to any of the above aspects, wherein contacting the treated boron nitride nanomaterial with the activating solution includes immersing the treated boron nitride nanomaterial in the activating solution, spraying the treated boron nitride nanomaterial with the activating solution, or a combination thereof.

In aspects, the techniques described herein relate to a method according to any of the above aspects, wherein the activating solution includes tin chloride, palladium chloride, hydrochloric acid, deionized water, or combinations thereof.

In aspects, the techniques described herein relate to a method according to any of the above aspects, further including rinsing the activated boron nitride nanomaterial.

In aspects, the techniques described herein relate to a method according to any of the above aspects, wherein contacting the activated boron nitride nanomaterial with the accelerator solution includes immersing the activated boron nitride nanomaterial in the accelerator solution, spraying the activated boron nitride nanomaterial with the accelerator solution, or a combination thereof.

In aspects, the techniques described herein relate to a method according to any of the above aspects, wherein the accelerator solution includes deionized water, hydrochloric acid, sulfuric acid, nitric acid, or combinations thereof.

In aspects, the techniques described herein relate to a method according to any of the above aspects, further including rinsing the accelerated boron nitride nanomaterial.

In aspects, the techniques described herein relate to a method according to any of the above aspects, wherein contacting the accelerated boron nitride nanomaterial with the plating solution includes immersing the accelerated boron nitride nanomaterial in the plating solution, spraying the accelerated boron nitride nanomaterial with the plating solution, or a combination thereof.

In aspects, the techniques described herein relate to a method according to any of the above aspects, wherein the metal includes copper, aluminum, zinc, nickel, silver, cadmium, chromium, gold, palladium, platinum, or combinations thereof.

In aspects, the techniques described herein relate to a method according to any of the above aspects, wherein the plating solution includes copper sulfate, copper chloride, copper nitrate, copper hydroxide, zinc sulfate, zinc chloride, zinc nitrate, zinc hydroxide, nickel acetate, nickel chloride, nickel nitrate, nickel sulfate, silver bromide, silver chloride, silver nitrate, cadmium chloride, cadmium acetate, cadmium sulfate, cadmium nitrate, chromium chloride, chromium nitrate, chromium acetate, chromium sulfate, gold chloride, gold nitrate, gold acetate, gold sulfate, palladium chloride, palladium nitrate, palladium acetate, palladium sulfate, platinum chloride, platinum nitrate, platinum acetate, platinum sulfate, or combinations thereof.

In aspects, the techniques described herein relate to a method according to any of the above aspects, wherein the plating solution further includes a complexing agent, a pH moderator, a reducing agent, or combinations thereof.

In aspects, the techniques described herein relate to a method according to any of the above aspects, wherein the plating solution further includes potassium sodium tartrate, ethylenediaminetetraacetic acid, triethanolamine, glyoxylic acid, citric acid, dimethylamine borane, sodium hydroxide, potassium hydroxide, ammonium hydroxide, triethanolamine, formaldehyde, sodium hypophosphite, hydrazine, or combinations thereof.

In aspects, the techniques described herein relate to a method according to any of the above aspects, further including rinsing the plated boron nitride nanomaterial.

In aspects, the techniques described herein relate to a method according to any of the above aspects, wherein drying the plated boron nitride nanomaterial includes dry filtering the plated boron nitride nanomaterial, heating the plated boron nitride nanomaterial, or a combination thereof.

In aspects, the techniques described herein relate to a method according to any of the above aspects, wherein the steps of performing a surface treatment on the boron nitride nanomaterial, contacting the treated boron nitride nanomaterial with an activating solution, contacting the activated boron nitride nanomaterial with an accelerator solution, contacting the accelerated boron nitride nanomaterial with a plating solution or combinations thereof further include stirring.

In aspects, the techniques described herein relate to a method according to any of the above aspects, further including processing the plated boron nitride nanomaterial.

In aspects, the techniques described herein relate to a method according to any of the above aspects, wherein processing the plated boron nitride nanomaterial includes a heat treatment, a chemical treatment, or a combination thereof.

In aspects, the techniques described herein relate to a composition, including: a boron nitride nanomaterial plated with a metal.

In aspects, the techniques described herein relate to a composition, wherein the boron nitride nanomaterial includes nanoparticles, nanoflakes, nanoplatelets, single-walled nanotubes, double-walled nanotubes, multi-walled nanotubes, or combinations thereof.

In aspects, the techniques described herein relate to a composition according to any of the above aspects, wherein the metal includes copper, aluminum, zinc, nickel, silver, cadmium, chromium, gold, palladium, platinum, or combinations thereof.

In aspects, the techniques described herein relate to a composition according to any of the above aspects, wherein the metal is in the form of copper sulfate, copper chloride, copper nitrate, copper hydroxide, zinc sulfate, zinc chloride, zinc nitrate, zinc hydroxide, nickel acetate, nickel chloride, nickel nitrate, nickel sulfate, silver bromide, silver chloride, silver nitrate, cadmium chloride, cadmium acetate, cadmium sulfate, cadmium nitrate, chromium chloride, chromium nitrate, chromium acetate, chromium sulfate, gold chloride, gold nitrate, gold acetate, gold sulfate, palladium chloride, palladium nitrate, palladium acetate, palladium sulfate, platinum chloride, platinum nitrate, platinum acetate, platinum sulfate, or combinations thereof.

In aspects, the techniques described herein relate to a composition according to any of the above aspects, wherein the composition is formed by steps of: performing a surface treatment on the boron nitride nanomaterial to form a treated boron nitride nanomaterial; contacting the treated boron nitride nanomaterial with an activating solution to form an activated boron nitride nanomaterial; contacting the activated boron nitride nanomaterial with an accelerator solution to form an accelerated boron nitride nanomaterial; contacting the accelerated boron nitride nanomaterial with a plating solution including a metal to form a plated boron nitride nanomaterial; and drying the plated boron nitride nanomaterial.

In aspects, the techniques described herein relate to a composite material, including the composition according to any of the above aspects and a polymer, a ceramic, a second metal, or combinations thereof.

### BRIEF DESCRIPTION OF THE DRAWINGS

Aspects, features, benefits, and advantages of the embodiments described herein will be apparent with regard to the following description, appended claims, and accompanying drawings where:

FIG. 1 is a flow chart of a method of making metal-plated boron nitride nanomaterials, according to an embodiment of the present disclosure.

FIG. 2 is an SEM image of un-plated boron nitride nanomaterial.

FIG. 3 is an EDS analysis of un-plated boron nitride nanomaterial.

FIG. 4 is a graph of particle size distribution of un-plated boron nitride nanomaterials.

FIG. 5 is an XRD pattern of the un-plated boron nitride nanomaterial.

FIG. 6A is a TEM image of un-plated boron nitride nanomaterial. FIG. 6B is a high-resolution TEM image of un-plated boron nitride nanomaterial at 5 nm scale magnification. FIG. 6C is a high-resolution TEM image of un-plated boron nitride nanomaterial at 1 nm scale magnification.

FIG. 7A and FIG. 7B are backscattered SEM images of copper plated BN nanomaterials, according to an embodiment of the present disclosure.

FIG. 8A is a SEM EDS mapping secondary electron image of copper plated BN nanomaterials, FIG. 8B shows copper mapping of copper plated BN nanomaterials, FIG. 8C shows boron mapping of copper plated BN nanomaterials, and FIG. 8D shows nitrogen mapping of copper plated BN nanomaterials, according to embodiments of the present disclosure.

FIG. 9 is an XRD pattern obtained from copper plated BN nanomaterials, according to an embodiment of the present disclosure.

FIG. 10A through FIG. 10E are STEM-EELS mapped images of copper plated BN nanomaterials, according to embodiments of the present disclosure. FIG. 10A is a STEM-high angle annular dark field (STEM-HAADF) image, FIG. 10B shows boron mapping, FIG. 10C shows nitrogen mapping, FIG. 10D shows copper mapping, and FIG. 10E shows a composite of boron, nitrogen, and copper, according to embodiments of the present disclosure.

FIG. 11A is a bright field, low magnification TEM image of boron nitride nanoflakes inside the copper matrix, according to an embodiment of the present disclosure. FIG. 11B is a bright field, high-resolution TEM image of the interface of the BN flake and the copper matrix, according to an embodiment of the present disclosure.

### DETAILED DESCRIPTION

The present disclosure describes boron nitride nanomaterials (BNNM) coated with a metal and electroless methods of making the same. The methods described herein offer a scalable, energy-efficient, and affordable alternative to traditional methods of producing nanomaterials-based composites.

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also includes exactly 50%. Stated differently, any value described herein as modified by “about” also discloses the exact value.

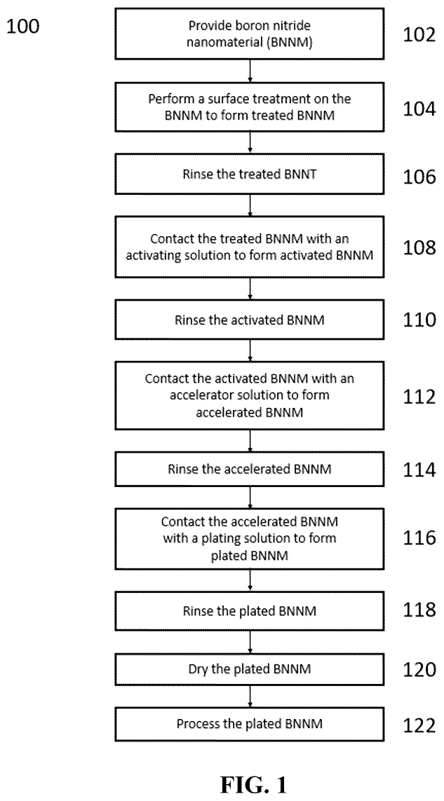

In embodiments, the present disclosure describes a method of producing metal-plated boron nitride nanomaterials. FIG. 1 is a flow chart of a method of making metal-plated boron nitride nanomaterials, according to an embodiment of the present disclosure. In embodiments, the method 100 includes steps of providing boron nitride nanomaterials 102, performing a surface treatment on the boron nitride nanomaterials to form treated boron nitride nanomaterials 104, rinsing the treated boron nitride nanomaterials 106, contacting the treated boron nitride nanomaterials with an activating solution to form activated boron nitride nanomaterials 108, rinsing the activated boron nitride nanomaterials 110, contacting the boron nitride nanomaterials with an accelerator solution to form accelerated boron nitride nanomaterials 112, rinsing the accelerated boron nitride nanomaterials 114, contacting the accelerated boron nitride nanomaterials with plating solution including a metal to form plated boron nitride nanomaterials 116, rinsing the plated boron nitride nanomaterials 118, drying the plated boron nitride nanomaterials 120, and optionally processing the plated boron nitride nanomaterials 122.

In embodiments, step 102 of the disclosed method includes providing boron nitride nanomaterials by any method known in the art are suited for use within the methods of the present disclosure. Properties of the boron nitride nanomaterials are not limited with respect to shape, thickness, number of layers, length, diameter, and the like. The boron nitride nanomaterials may include single, double, or multi-walled structures. In embodiments, the boron nitride nanomaterials may include boron nitride nanotubes, nanosheets, or other boron nitride nanostructures. In embodiments, the boron nitride nanomaterial includes nanoparticles, nanoflakes, nanoplatelets, single-walled nanotubes, double-walled nanotubes, multi-walled nanotubes, or combinations thereof.

In embodiments, step 104 of the disclosed method may include performing a surface treatment on the boron nitride nanomaterials to form treated boron nitride nanomaterials. In embodiments, the surface treatment includes immersing the boron nitride nanomaterials in a solution of an acid. In embodiments, the acid includes hydrochloric acid, sulfuric acid, nitric acid, or combinations thereof. In embodiments of the present disclosure, the solution of acid has a total concentration of acid of greater than or equal to about 0.1 M to less than or equal to about 3 M, such as about 0.1 M, about 0.5, about 1 M, about 1.5 M, about 2 M, about 2.5 M, about 3 M, or any value contained within a range formed by any two of the preceding values. In embodiments, immersing the boron nitride nanomaterials in the solution of the acid occurs for a time of greater than or equal to about 30 seconds to less than or equal to about 2 hours, for example about 30 seconds, about 1 minute, about 2 minutes, about 3 minutes, about 4 minutes, about 5 minutes, about 6 minutes, about 7 minutes, about 8 minutes, about 9 minutes, about 10 minutes, about 20 minutes, about 30 minutes, about 40 minutes, about 50 minutes, about 1 hour, about 2 hours, or any value contained within a range formed by any two of the preceding values. In embodiments, the step of performing a surface treatment on the boron nitride nanomaterials 104 is followed by subjecting the treated boron nitride nanomaterials to ultrasonication, magnetic stirring, or combinations thereof. Performing step 104 of the disclosed method forms treated boron nitride nanomaterials, according to embodiments of the present disclosure.

In embodiments, step 106 of the disclosed method includes rinsing the treated boron nitride nanomaterials. In embodiments, the treated boron nitride nanomaterials are rinsed with deionized water. In embodiments, the treated boron nitride nanomaterials may be rinsed multiple times, such as once, twice, three times, four times, and so forth.

In embodiments, step 108 of the disclosed method includes contacting the treated boron nitride nanomaterials with an activating solution to form activated boron nitride nanomaterials. Contacting the treated boron nitride nanomaterials may include immersing the treated boron nitride nanomaterials in an activating solution, and then removing the treated boron nitride nanomaterials from the activation solution. In embodiments, contacting the treated boron nitride nanomaterials with the activating solution may include spraying the activating solution onto the treated boron nitride nanomaterials. In embodiments, the activating solution may include tin chloride, palladium chloride, hydrochloric acid, deionized water, or combinations thereof. In embodiments, the activating solution includes tin chloride in a concentration of greater than or equal to about 0.0005 M to less than or equal to about 0.5 M, such as about 0.05 M, about 0.1 M, about 0.2 M, about 0.3 M, about 0.4 M, about 0.5 M, or any value contained within a range formed by any two of the preceding values. In embodiments, the activating solution includes palladium chloride in a concentration of greater than or equal to about 0.0004 M to less than or about 0.01 M, for example, about 0.0005 M, about 0.001 M, about 0.0015 M, about 0.002 M, about 0.0025 M, about 0.003 M, about 0.0035 M, about 0.004 M, about 0.0045 M, about 0.005 M, about 0.0055 M, about 0.006 M, about 0.0065 M, about 0.007 M, about 0.0075 M, about 0.008 M, about 0.0085 M, about 0.009 M, about 0.0095 M, about 0.01 M, or any value contained within a range formed by any two of the preceding values.

In embodiments, the treated boron nitride nanomaterials may be contacted with the activating solution for a time of greater than or equal to about 10 minutes, for example, about 10 minutes, about 20 minutes, about 30 minutes, about 40 minutes, about 50 minutes, about 1 hour, and so forth, or any value contained within a range formed by any two of the preceding values. In embodiments, the boron nitride nanomaterials are subjected to ultrasonication, magnetic stirring, or combinations thereof, during, after, or both during and after immersion in the activating solution. Performing step 108 of method 100 forms activated boron nitride nanomaterials, according to embodiments of the present disclosure. In embodiments, the activated boron nitride nanomaterials are filtered after they are removed from the activating solution. In embodiments, the BN nanomaterials are immersed in the activating solution and then filter dried after removal from the activating solution.

In embodiments, step 110 of the disclosed method includes rinsing the activated boron nitride nanomaterials. In embodiments, the activated boron nitride nanomaterials are rinsed with deionized water. In embodiments, the activated boron nitride nanomaterials may be rinsed multiple times, such as once, twice, three times, four times, and so forth.

In embodiments, step 112 of the disclosed method includes contacting the boron nitride nanomaterials with an accelerator solution to form accelerated boron nitride nanomaterials. In embodiments, the accelerator solution includes an aqueous acidic solution, such as hydrochloric acid, sulfuric acid, nitric acid, or combinations thereof. In embodiments, the accelerator solution includes an acid, such as those described herein, in solution in deionized water. Performing step 112 of the disclosed method forms accelerated boron nitride nanomaterials, according to embodiments of the present disclosure.

In embodiments, step 114 of the disclosed method includes rinsing the accelerated boron nitride nanomaterials. In embodiments, the accelerated boron nitride nanomaterials are rinsed with deionized water. The accelerated BN nanomaterials may be rinsed multiple times such as once, twice, three times, four times, and so forth.

In embodiments, step 116 of the disclosed method includes plating the accelerated boron nitride nanomaterials with a metal to form plated boron nitride nanomaterials. In embodiments, plating the accelerated boron nitride nanomaterials includes contacting the accelerated boron nitride nanomaterials with a plating solution which includes a metal. In embodiments, the metal may be in the form of a metal salt or metal-containing compound. In embodiments, the metal includes copper, aluminum, zinc, nickel, silver, cadmium, chromium, gold, platinum, palladium, the like, or combinations thereof. In embodiments, the metal salt or metal-containing compound includes copper sulfate, copper chloride, copper nitrate, copper hydroxide, zinc sulfate, zinc chloride, zinc nitrate, zinc hydroxide, nickel acetate, nickel chloride, nickel nitrate, nickel sulfate, silver bromide, silver chloride, silver nitrate, cadmium chloride, cadmium acetate, cadmium sulfate, cadmium nitrate, chromium chloride, chromium nitrate, chromium acetate, chromium sulfate, gold chloride, gold nitrate, gold acetate, gold sulfate, palladium chloride, palladium nitrate, palladium acetate, palladium sulfate, platinum chloride, platinum nitrate, platinum acetate, platinum sulfate, the like, or combinations thereof.

In embodiments, the plating solution may further include one or more of a complexing agent, a pH moderator, a reducing agent, or combinations thereof. In embodiments, the complexing agent may include potassium sodium tartrate (Rochelle salt), ethylenediaminetetraacetic acid (EDTA), triethanolamine (TEOA), glyoxylic acid, citric acid, dimethylamine borane (DMAB), or combinations thereof. The plating solution may also include a pH moderator, such as sodium hydroxide (NaOH), potassium hydroxide (KOH), ammonium hydroxide (NH₄OH), triethanolamine (TEOA), or combinations thereof. The plating solution may also include a reducing agent, such as formaldehyde (HCHO), sodium hypophosphite (NaH₂PO₂), dimethylamine borane (DMAB), hydrazine (N₂H₄), glyoxylic acid, or combinations thereof.

In embodiments, the metal has a concentration of greater than or equal to about 0.005 M to less than or equal to about 1 M in the plating solution, such as about 0.005 M, about 0.01 M, about 0.05 M, about 0.1 M, about 0.2 M, about 0.3 M, about 0.4 M, about 0.5 M, about 0.6 M, about 0.7 M, about 0.8 M, about 0.9 M, about 1.0 M, or any value contained within a range formed by any two of the preceding values. In embodiments, the complexing agent has a concentration of greater than or equal to about 0.05 M to less than or equal to about 0.1 M, such as about 0.05 M, about 0.06 M, about 0.07 M, about 0.08 M, about 0.09 M, about 0.1 M, or any value contained within a range formed by any two of the preceding values. In embodiments, the pH moderator may be included in an amount sufficient to maintain the pH value at greater than or equal to about 12 to less than or equal to about 13.

In embodiments, the activated boron nitride nanomaterials are contacted with the plating solution for a time of greater than or equal to about 10 minutes to less than or equal to about 1 hour, such as about 10 minutes, about 20 minutes, about 30 minutes, about 40 minutes, about 50 minutes, about 1 hour, or any value contained within a range formed by any two of the preceding values. In embodiments, the degree of plating of the boron nitride nanomaterials may be evaluated by methods familiar to those skilled in the art, such as scanning electron microscopy (SEM), energy dispersive spectroscopy (EDS), transmission electron microscopy (TEM), and the like. Performing step 116 of method 100 forms plated boron nitride nanomaterials, according to embodiments of the present disclosure. In embodiments, step 116 of the disclosed method further includes removing the plated boron nitride nanomaterials from the plating solution.

In embodiments, step 118 of the present method includes rinsing the plated boron nitride nanomaterials. In embodiments, the plated boron nitride nanomaterials are rinsed with deionized water. In embodiments, the plated boron nitride nanomaterials may be rinsed multiple times, such as once, twice, three times, four times, and so forth.

In embodiments, step 120 of the disclosed method includes drying the plated boron nitride nanomaterials. In embodiments, drying the plated boron nitride nanomaterials includes dry filtering the plated boron nitride nanomaterial, heating the boron nitride nanomaterials, or combinations thereof.

In embodiments, the method includes an optional step 122 of processing the plated boron nitride nanomaterials 122. Plated boron nitride nanomaterials can be further post-processed by different methods such as heat treatment, chemical treatment, the like, or combinations to further enhance the quality of the metal plating on the BN nanomaterials or modify the chemical composition of the plating. Thus, in embodiments, the method may further include processing the plated boron nitride nanomaterials 122. In embodiments, step 122 is not performed, such that the boron nitride nanomaterials are not processed.

The above-described embodiments may further include stirring and sonication before, during, or after each step of the disclosed method. Stirring may include magnetic agitation, manual agitation, or other methods of stirring known to those skilled in the art. As well as sonication including probe sonication and other sonication methods known to those skilled in the art.

According to embodiments of the present disclosure, there is also provided a composition which includes boron nitride nanomaterials and a metal. In embodiments, the metal includes copper, aluminum, zinc, nickel, silver, cadmium, chromium, gold, palladium, platinum, or combinations thereof. In embodiments, the metal is in the form of a metal salt or metal-containing compound, such as copper sulfate, copper chloride, copper nitrate, copper hydroxide, zinc sulfate, zinc chloride, zinc nitrate, zinc hydroxide, nickel acetate, nickel chloride, nickel nitrate, nickel sulfate, silver bromide, silver chloride, silver nitrate, cadmium chloride, cadmium acetate, cadmium sulfate, cadmium nitrate, chromium chloride, chromium nitrate, chromium acetate, chromium sulfate, gold chloride, gold nitrate, gold acetate, gold sulfate, palladium chloride, palladium nitrate, palladium acetate, palladium sulfate, platinum chloride, platinum nitrate, platinum acetate, platinum sulfate, the like, or combinations thereof. Other compounds of the metals disclosed herein may also be employed in the compositions and methods of the present disclosure. In embodiments, the metal is plated onto the boron nitride nanomaterials, such that the composition includes metal-plated boron nitride nanomaterials.

In embodiments, the metal-plated boron nitride nanomaterials may be formed by methods as disclosed herein, such as a method including providing boron nitride nanomaterials, performing a surface treatment on the boron nitride nanomaterials to form treated boron nitride nanomaterials, rinsing the treated boron nitride nanomaterials, contacting the treated boron nitride nanomaterials with an activating solution to form activated boron nitride nanomaterials, rinsing the activated boron nitride nanomaterials, contacting the boron nitride nanomaterials with an accelerator solution to form accelerated boron nitride nanomaterials, rinsing the accelerated boron nitride nanomaterials, plating the accelerated boron nitride nanomaterials with a metal to form plated boron nitride nanomaterials, rinsing the plated boron nitride nanomaterials, and drying the plated boron nitride nanomaterials. In embodiments, the metal-plated boron nitride nanomaterials are formed according to the method of producing metal-plated boron nitride nanomaterials as described herein, and in other embodiments, the metal-plated boron nitride nanomaterials may be formed by other methods.

The metal-plated boron nitride nanomaterials disclosed herein, along with the un-plated boron nitride nanomaterials from which the plated BNNM of the present disclosure are produced, have been characterized using scanning electron microscope (SEM), X-ray diffraction (XRD), Transmission Electron Microscopy (TEM), along with Energy Dispersive Spectroscopy (EDS) and Electron Energy Loss Spectroscopy (EELS).

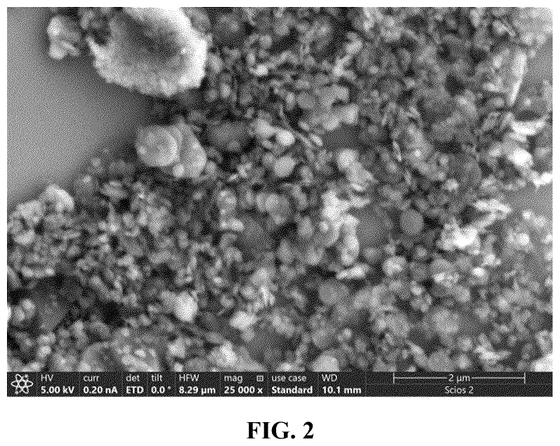

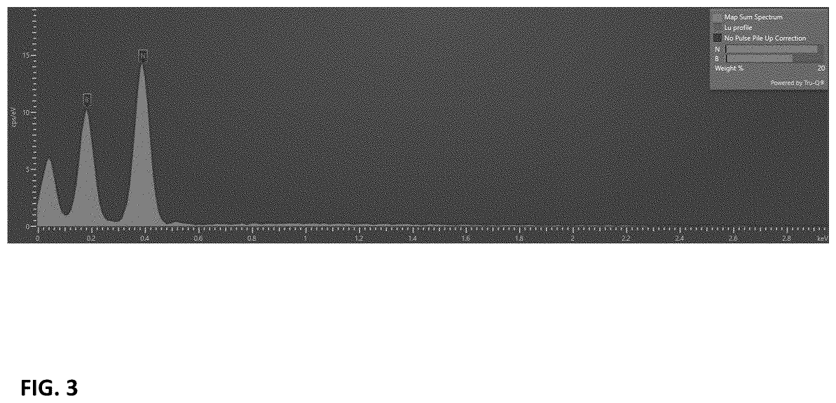

FIG. 2 is an SEM image of un-plated boron nitride nanomaterials. As shown in FIG. 2, the un-plated BNNM is in the form of thin sheets and the size of the sheets is in the range of a few hundreds of nanometers. FIG. 3 is an EDS analysis of the un-plated boron nitride nanomaterial. The peaks indicate the weight percentage of boron and nitrogen present in the nanomaterial.

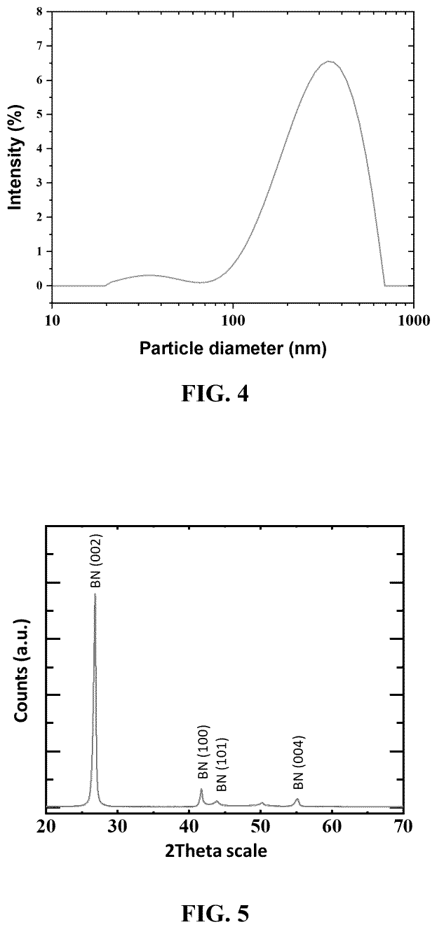

FIG. 4 is a graph of particle size distribution of un-plated boron nitride nanomaterials. The size of the BN sheets was further characterized using dynamic light scattering (DLS), in which the size distribution of the sheets was found to be within the range of tens to hundreds of nanometers, as illustrated in FIG. 4.

FIG. 5 is an XRD pattern of un-plated boron nitride nanomaterial. The crystalline planes are matched with the hexagonal boron nitride crystal structure. The dominant planes (002), (004) along with other planes (100), (101) were observed. The sharp peaks indicate high degree of crystallinity of the BN nanomaterial utilized in the methods and compositions of the present disclosure.

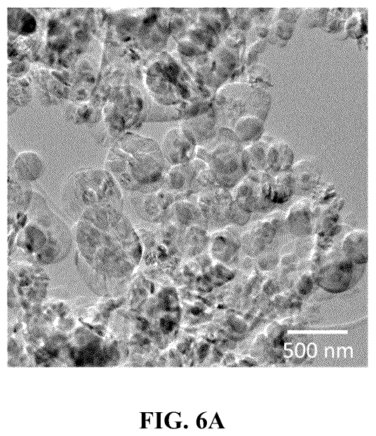

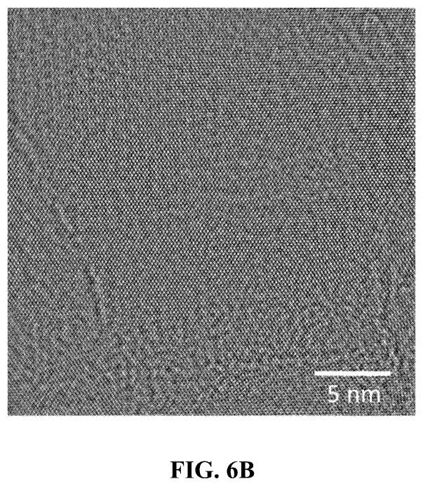

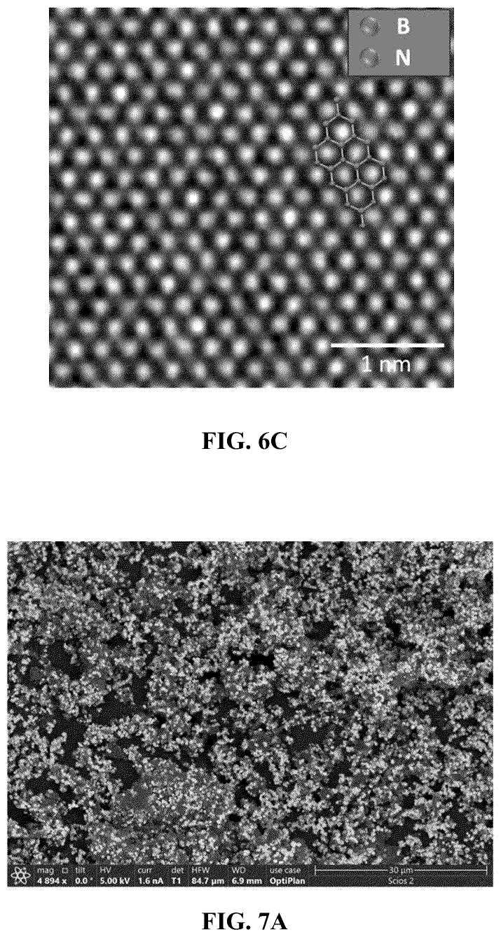

FIG. 6A is a TEM image of un-plated boron nitride nanomaterial. As shown in FIG. 6A, the BN flakes have sizes of few hundreds of nanometers. The flakes have nearly circular to oval shape, without wishing to be bound by theory. The size and the shape are correlated with the SEM image shown in FIG. 2. FIG. 6B is a high-resolution TEM image of un-plated boron nitride nanomaterial at 5 nm scale magnification. FIG. 6C is a high-resolution TEM image of un-plated boron nitride nanomaterial at 1 nm scale magnification. FIG. 6B and FIG. 6C indicate the defect free, highly crystalline nature of the BN nanomaterials used in present plating method. The flakes in the images are oriented along the [002] zone axis.

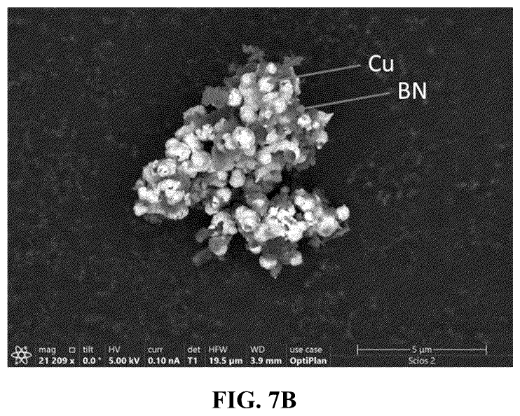

FIG. 7A and FIG. 7B are backscattered SEM images of copper plated BN nanomaterials, according to an embodiment of the present disclosure. The Cu-plated BNNM were glued onto a carbon tape for imaging. The randomly distributed coated BN particles can be seen in FIG. 7A and FIG. 7B. Backscattering imaging is highly sensitive to the atomic number of the elements, and the intensity (the integrated collected signal for imaging) is higher for high Z (atomic number) elements and lower for low Z elements. The SEM images in FIG. 7A and FIG. 7B show both high intensity and low intensity regions in the distributed particles indicating the Cu plated BN nanomaterials. The distinctive Cu plated regions and the BN regions are marked in FIG. 7B.

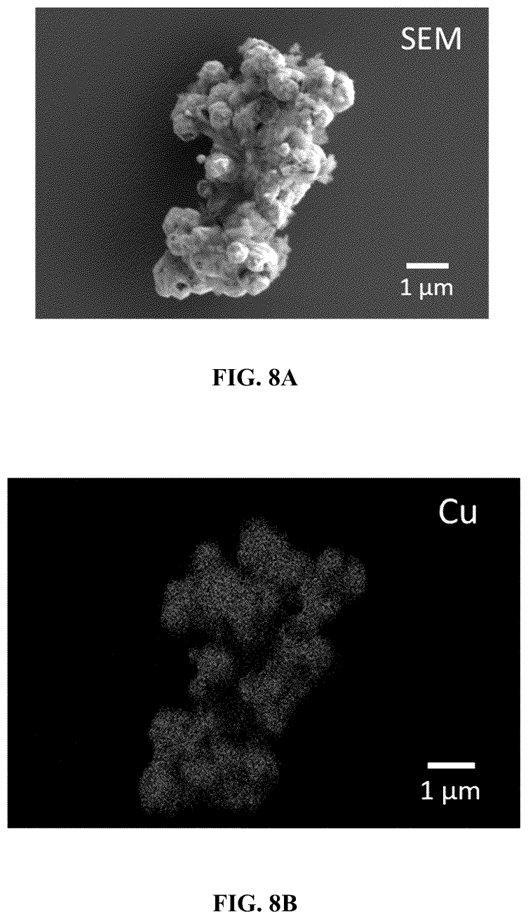

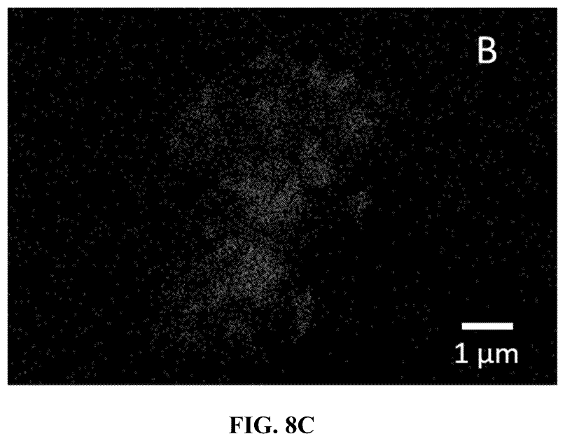

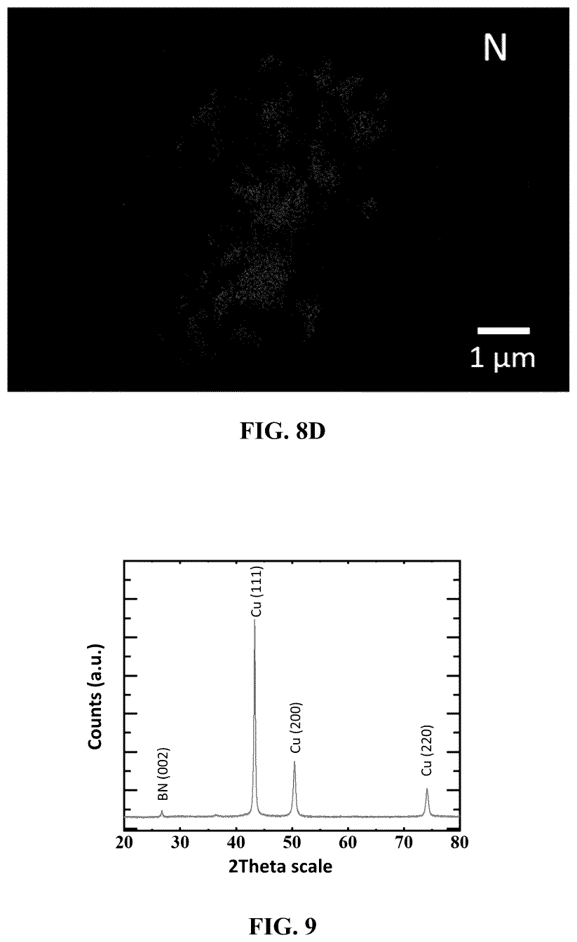

FIG. 8A is a SEM EDS mapping secondary electron image of copper plated BN nanomaterials, FIG. 8B shows copper mapping of copper plated BN nanomaterials, FIG. 8C shows boron mapping of copper plated BN nanomaterials, and FIG. 8D shows nitrogen mapping of copper plated BN nanomaterials, according to embodiments of the present disclosure. FIGS. 8A-8D clearly show the elements boron and nitrogen, corresponding to the BN nanomaterials, along with the plated Cu element.

FIG. 9 is an XRD pattern obtained from copper plated BN nanomaterials, according to an embodiment of the present disclosure. The XRD pattern shows sharp intensity, indicating the high crystallinity of the material. The planes are identified and shown in FIG. 9. A small peak of the h-BN plane (002) along with the Cu planes (111), (200) and (220) can be recognized in the diffraction pattern. The XRD in FIG. 9 confirms the retention of the crystalline nature of the BN flakes after the plating process, without wishing to be bound by theory.

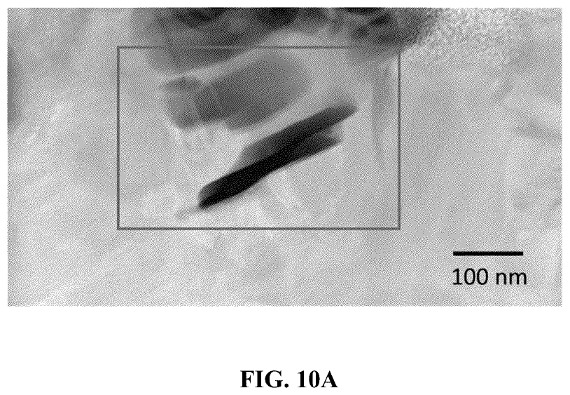

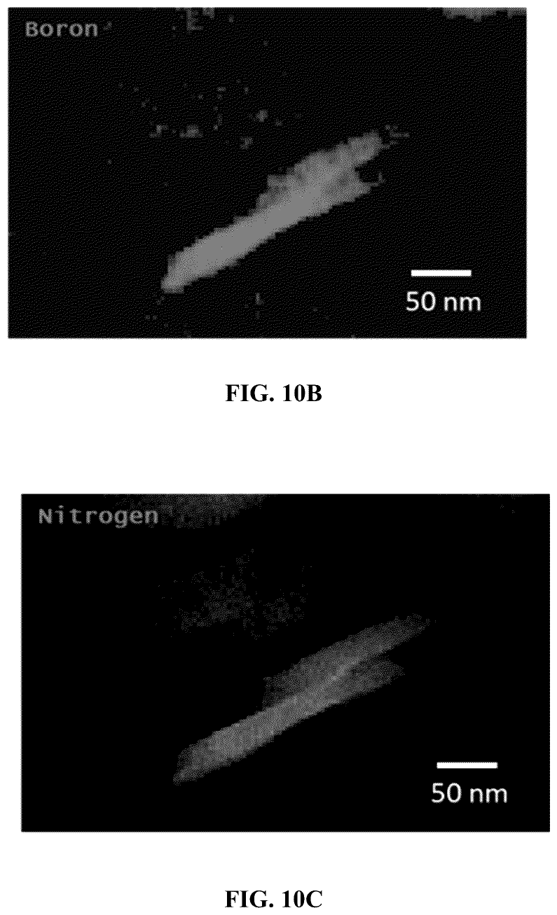

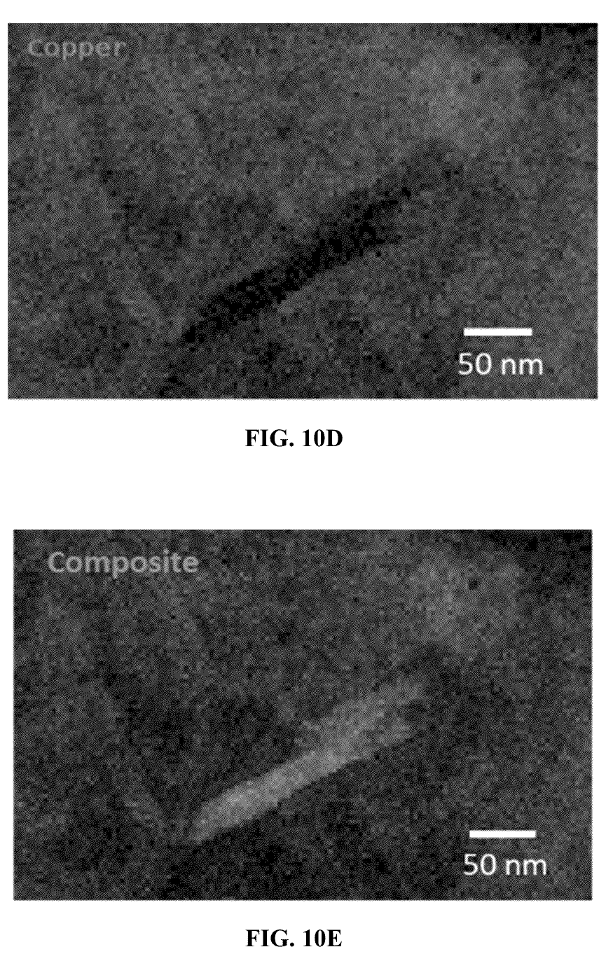

FIG. 10A through FIG. 10E are STEM-EELS mapped images of copper plated

BN nanomaterials, according to embodiments of the present disclosure. Standard FIB lift-out TEM lamella preparation technique was used to prepare thin lamella samples. Scanning Transmission Electron Microscopy (STEM)-EELS mapping was carried out on the prepared Cu-plated BN nanomaterial TEM samples. FIG. 10A is a STEM-high angle annular dark field (STEM-HAADF) image, FIG. 10B shows boron mapping, FIG. 10C shows nitrogen mapping, FIG. 10D shows copper mapping, and FIG. 10E shows a composite of boron, nitrogen, and copper, according to embodiments of the present disclosure. The mapped images and composite image FIG. 10E indicate the presence of BN flakes inside the Cu matrix.

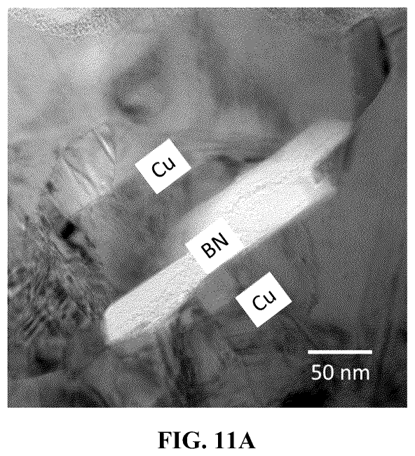

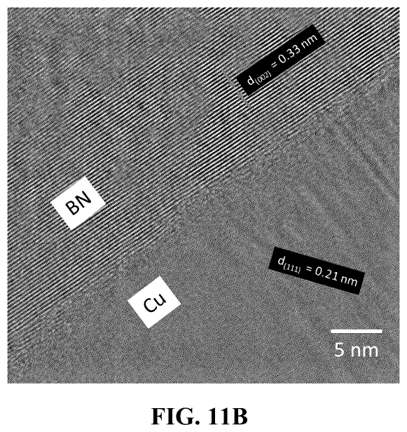

FIG. 11A is a bright field, low magnification TEM image of boron nitride nanoflakes inside the copper matrix, according to an embodiment of the present disclosure. FIG. 11B is a bright field, high-resolution TEM image of the interface of the BN flake and the copper matrix, according to an embodiment of the present disclosure. Bright field TEM imaging was performed on the BN nanoflakes residing inside the Cu matrix. FIG. 11A is a bright field TEM image taken from one region of the prepared TEM lamella. The brighter regions in the middle indicate the BN flakes, without wishing to be bound by theory. The Cu and the BN regions are marked and shown in FIG. 11A. A high-resolution TEM (HRTEM) image was taken from the interface of the BN and the Cu matrix region. The interlayer distance of the BN layers was found to be 0.33 nm, which corresponds to the crystalline plane of (002) of hexagonal BN crystal. Similarly, the crystalline plane of Cu from the Cu region is identified as (111) plane with d=0.21 nm and is marked in FIG. 11B.

In embodiments, the metal-plated boron nitride nanomaterials of the present disclosure can be incorporated into a composite material which further includes a second metal, a polymer, a ceramic, or combinations thereof. In embodiments, the metal-plated boron nitride nanomaterials may exhibit improved dispersion throughout the composite material than boron nitride nanomaterials which are not coated with a metal. In embodiments, a composite material which includes metal-plated boron nitride nanomaterials may exhibit a higher mechanical strength, higher elastic modulus, improved oxidation stability, and/or higher conductivity than a composite material which does not include metal-plated boron nitride nanomaterials. The metal-plated boron nitride nanomaterials described herein may be utilized in electronics and other advanced materials, according to some embodiments of the present disclosure. The metal-plated boron nitride nanomaterials described herein may be used for enhancing the mechanical and functional performance of metallic alloy matrix composites, polymer matrix composites, ceramic matrix composites, and the like.

### EXAMPLES

Metal-plated boron nitride nanomaterials were prepared according to an embodiment of the present disclosure. Approximately 0.05 g of BN nanomaterial were sonicated for 1 hour in 1 M HCl as a surface treatment, then the treated BNNM was dry filtered. Next, a palladium-tin solution (Pd-Sn) was prepared using 0.07 g of palladium and 0.01 g of tin dissolved in 100 mL deionized (DI) water and agitated well, for use as the activating solution. Afterwards, the treated BNNM were immersed in an activation solution of 25 mL of Pd-Sn, 55 mL of DI water, and 20 mL HCl. The treated BNNM were sonicated for 3 minutes in the activating solution and magnetically stirred for 7 minutes. The activated BNNM were then rinsed and dry filtered. Next, the activated BNNM was contacted with an accelerator solution of 1 M HCl and stirred for 5 minutes, then rinsed with DI water and dry filtered. Finally, an electrolyte bath was prepared using 100 mL of DI water, 0.7 g of copper sulfate, 2.25 g of Rochelle salt, and an appropriate amount of Sodium hydroxide (NaOH) to keep the pH at a value of at least 12. All components were agitated well. The accelerated BNNM was introduced to this electrolyte bath and 1 mL of formaldehyde was added to start the reaction. The reaction was allowed to proceed under sonication for 20 minutes, then the plated BNNM was filtered and dried at room temperature.

The above example is non-limiting, and other variations of the present method may be performed and are within the scope of the present disclosure.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A method of producing a metal-plated boron nitride nanomaterial, comprising steps of:
performing a surface treatment on a boron nitride nanomaterial to form a treated boron nitride nanomaterial;
contacting the treated boron nitride nanomaterial with an activating solution to form an activated boron nitride nanomaterial;
contacting the activated boron nitride nanomaterial with an accelerator solution to form an accelerated boron nitride nanomaterial;
contacting the accelerated boron nitride nanomaterial with a plating solution comprising a metal to form a plated boron nitride nanomaterial; and
drying the plated boron nitride nanomaterial.

2. The method of claim 1, wherein the surface treatment comprises contacting the boron nitride nanomaterial with a solution of an acid.

3. The method of claim 1, wherein the surface treatment comprising contacting the boron nitride nanomaterial with an acid comprising hydrochloric acid, sulfuric acid, nitric acid, or combinations thereof.

4. The method of claim 1, further comprising rinsing the treated boron nitride nanomaterial.

5. The method of claim 1, wherein contacting the treated boron nitride nanomaterial with the activating solution comprises immersing the treated boron nitride nanomaterial in the activating solution, spraying the treated boron nitride nanomaterial with the activating solution, or a combination thereof.

6. The method of claim 1, wherein the activating solution comprises tin chloride, palladium chloride, hydrochloric acid, deionized water, or combinations thereof.

7. The method of claim 1, further comprising rinsing the activated boron nitride nanomaterial.

8. The method of claim 1, wherein contacting the activated boron nitride nanomaterial with the accelerator solution comprises immersing the activated boron nitride nanomaterial in the accelerator solution, spraying the activated boron nitride nanomaterial with the accelerator solution, or a combination thereof.

9. The method of claim 1, wherein the accelerator solution comprises deionized water, hydrochloric acid, sulfuric acid, nitric acid, or combinations thereof.

10. The method of claim 1, further comprising rinsing the accelerated boron nitride nanomaterial.

11. The method of claim 1, wherein contacting the accelerated boron nitride nanomaterial with the plating solution comprises immersing the accelerated boron nitride nanomaterial in the plating solution, spraying the accelerated boron nitride nanomaterial with the plating solution, or a combination thereof.

12. The method of claim 1, wherein the metal comprises copper, aluminum, zinc, nickel, silver, cadmium, chromium, gold, palladium, platinum, or combinations thereof.

13. The method of claim 1, wherein the plating solution comprises copper sulfate, copper chloride, copper nitrate, copper hydroxide, zinc sulfate, zinc chloride, zinc nitrate, zinc hydroxide, nickel acetate, nickel chloride, nickel nitrate, nickel sulfate, silver bromide, silver chloride, silver nitrate, cadmium chloride, cadmium acetate, cadmium sulfate, cadmium nitrate, chromium chloride, chromium nitrate, chromium acetate, chromium sulfate, gold chloride, gold nitrate, gold acetate, gold sulfate, palladium chloride, palladium nitrate, palladium acetate, palladium sulfate, platinum chloride, platinum nitrate, platinum acetate, platinum sulfate, or combinations thereof.

14. The method of claim 1, wherein the plating solution further comprises a complexing agent, a pH moderator, a reducing agent, or combinations thereof.

15. The method of claim 1, wherein the plating solution further comprises potassium sodium tartrate, ethylenediaminetetraacetic acid, triethanolamine, glyoxylic acid, citric acid, dimethylamine borane, sodium hydroxide, potassium hydroxide, ammonium hydroxide, triethanolamine, formaldehyde, sodium hypophosphite, hydrazine, or combinations thereof.

16. The method of claim 1, further comprising rinsing the plated boron nitride nanomaterial.

17. The method of claim 1, wherein drying the plated boron nitride nanomaterial comprises dry filtering the plated boron nitride nanomaterial, heating the plated boron nitride nanomaterial, or a combination thereof.

18. The method of claim 1, wherein the steps of performing a surface treatment on the boron nitride nanomaterial, contacting the treated boron nitride nanomaterial with an activating solution, contacting the activated boron nitride nanomaterial with an accelerator solution, contacting the accelerated boron nitride nanomaterial with a plating solution or combinations thereof further comprise stirring.

19. The method of claim 1, further comprising processing the plated boron nitride nanomaterial.

20. The method of claim 19, wherein processing the plated boron nitride nanomaterial comprises a heat treatment, a chemical treatment, or a combination thereof.

21. A composition, comprising:
a boron nitride nanomaterial plated with a metal.

22. The composition of claim 21, wherein the boron nitride nanomaterial comprises nanoparticles, nanoflakes, nanoplatelets, single-walled nanotubes, double-walled nanotubes, multi-walled nanotubes, or combinations thereof.

23. The composition of claim 21, wherein the metal comprises copper, aluminum, zinc, nickel, silver, cadmium, chromium, gold, palladium, platinum, or combinations thereof.

24. The composition of claim 21, wherein the metal is in the form of copper sulfate, copper chloride, copper nitrate, copper hydroxide, zinc sulfate, zinc chloride, zinc nitrate, zinc hydroxide, nickel acetate, nickel chloride, nickel nitrate, nickel sulfate, silver bromide, silver chloride, silver nitrate, cadmium chloride, cadmium acetate, cadmium sulfate, cadmium nitrate, chromium chloride, chromium nitrate, chromium acetate, chromium sulfate, gold chloride, gold nitrate, gold acetate, gold sulfate, palladium chloride, palladium nitrate, palladium acetate, palladium sulfate, platinum chloride, platinum nitrate, platinum acetate, platinum sulfate, or combinations thereof.

25. The composition of claim 21, wherein the composition is formed by steps of:
performing a surface treatment on the boron nitride nanomaterial to form a treated boron nitride nanomaterial;
contacting the treated boron nitride nanomaterial with an activating solution to form an activated boron nitride nanomaterial;
contacting the activated boron nitride nanomaterial with an accelerator solution to form an accelerated boron nitride nanomaterial;
contacting the accelerated boron nitride nanomaterial with a plating solution comprising a metal to form a plated boron nitride nanomaterial; and
drying the plated boron nitride nanomaterial.

26. A composite material, comprising the composition of claim 21 and a polymer, a ceramic, a second metal, or combinations thereof.
